(19) United States
(12) Patent Application Publication
(10) Pub. No.: US 2026/0073671 A1
(43) Pub. Date: Mar. 12, 2026

(54) ACTION CONCEPT ENHANCEMENT OF VIDEO-LANGUAGE MODELS IN PROCEDURAL VIDEOS

(71) Applicant: Honda Motor Co., Ltd., Tokyo (JP)

(72) Inventors: Reza Ghoddoosian, San Jose, CA (US); Nakul Agarwal, San Francisco, CA (US); Isht Dwivedi, Mountain View, CA (US); Behzad Dariush, San Ramon, CA (US)

(21) Appl. No.: 19/085,019

(22) Filed: Mar. 20, 2025

Related U.S. Application Data
(60) Provisional application No. 63/692,575, filed on Sep. 9, 2024.

(51) Int. Cl. G06V 10/774; G06F 40/247; G06F 40/253; G06F 40/40; G06V 10/764; G06V 20/40

(52) U.S. Cl. CPC G06V 10/7747; G06F 40/247; G06F 40/253; G06F 40/40; G06V 10/764; G06V 20/41; G06V 20/44

(57) ABSTRACT

The disclosure provides systems/methods of refining a video language model to identify unseen actions. The computer-implemented method can include obtaining a video language model that is pretrained on a dataset of video clips labeled with object and verb pairings. The method can include constructing a synonym tree, where each node is verb from the object and verb pairing of the dataset and its descendants are synonyms. The synonyms can be provided by generating, by a large language model, a random sample of synonyms for each verb in the object and verb pairings of the action labels. During training, a classification loss function can be used where videos are classified into novel combinations of action/verb synonyms and their negatives, randomly chosen from the tree. This method can generate numerous action label combinations, ensuring the model encounters new or rare action sets each iteration, simulating classification into unseen categories.

### TECHNICAL FIELD

The embodiments disclosed are related to understanding human actions in procedural videos for a plurality of applications, including, but not limited to, training, human-robot interaction, and anomaly detection.

### BACKGROUND

Understanding human actions in procedural videos—such as cooking or assembly—has numerous applications, including training, and human-robot interaction. Because models for understanding human actions in procedural videos are typically trained on seen classes (e.g., classes actions related to desired outcomes), these models struggle to detect anomalies, such as accidental actions. For example, in a smart kitchen, since it is impractical to gather data for scenarios like “dropping a spatula” or “spilling water,” an intelligent assistant cannot identify and respond to such actions accurately. Anomalies can appear as missed steps, redundant actions, deviations from sequences, or departures from expert performance because anomalies do not belong in seen classes.

There is a need in the art for a system and method that addresses the shortcomings discussed above.

### SUMMARY

In one aspect, the disclosure provides a computer-implemented method of refining a video language model to identify unseen actions. The computer-implemented method can include obtaining a pretrained video language model that is pretrained on a first set of object and verb pairing datasets to map input video embeddings and action label embeddings (the action labels including object and verb pairings) into a shared dimensional space such that cross-modal similarity between an input video and its ground truth action label is maximized. The computer-implemented method can include generating a random sample of synonyms for each verb in the object and verb pairings of the action labels. The computer-implemented method can include building digital verb synonym tree structures in which parent nodes in individual verb synonym tree structures include root verbs and child nodes that branch from the parent nodes are the selected synonyms corresponding to the root verb. The computer-implemented method can include training the pretrained video language model on a second set of object and verb pairing datasets, wherein each object and verb pairing of the second set includes the object in the first set of object and verb pairing datasets and a verb that is a child node of the root verb originally paired with the object in the first set of object and verb pairing datasets, to map input video embeddings and action label embeddings.

In another aspect, the disclosure provides a system for refining a video language model to identify unseen actions including one or more computers and one or more storage devices storing instructions. The instructions can be executable to by the one or more computers to obtain a pretrained video language model that is pretrained on a first set of object and verb pairing datasets to map input video embeddings and action label embeddings (the action labels including object and verb pairings) into a shared dimensional space such that cross-modal similarity between an input video and its ground truth action label is maximized. The instructions can be executable to by the one or more computers to generate a random sample of synonyms for each verb in the object and verb pairings of the action labels. The instructions can be executable to by the one or more computers to build digital verb synonym tree structures in which parent nodes in individual verb synonym tree structures include root verbs and child nodes that branch from the parent nodes are the selected synonyms corresponding to the root verb. The instructions can be executable to by the one or more computers to train the pretrained video language model on a second set of object and verb pairing datasets, wherein each object and verb pairing of the second set includes the object in the first set of object and verb pairing datasets and a verb that is a child node of the root verb originally paired with the object in the first set of object and verb pairing datasets, to map input video embeddings and action label embeddings.

In yet another aspect, the disclosure provides a system for refining a video language model to identify unseen actions. The system can include one or more computers and one or more storage devices storing instructions. The instructions can be executable to by the one or more computers to obtain a pretrained video language model that is pretrained on a first set of object and verb pairing datasets to map input video embeddings and action label embeddings (the action labels including object and verb pairings) into a shared dimensional space such that cross-modal similarity between an input video and its ground truth action label is maximized. The instructions can be executable to by the one or more computers to generate a random sample of synonyms for each verb in the object and verb pairings of the action labels. The instructions can be executable to by the one or more computers to build digital verb synonym tree structures in which parent nodes in individual verb synonym tree structures include root verbs and child nodes that branch from the parent nodes are the selected synonyms corresponding to the root verb. The instructions can be executable to by the one or more computers to train the pretrained video language model on a second set of object and verb pairing datasets, wherein each object and verb pairing of the second set includes the object in the first set of object and verb pairing datasets and a verb that is a child node of the root verb originally paired with the object in the first set of object and verb pairing datasets, to map input video embeddings and action label embeddings.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

While various embodiments are described, the description is intended to be exemplary, rather than limiting, and it will be apparent to those of ordinary skill in the art that many more embodiments and implementations are possible that are within the scope of the embodiments. Although many possible combinations of features are shown in the accompanying figures and discussed in this detailed description, many other combinations of the disclosed features are possible. Any feature or element of any embodiment may be used in combination with or substituted for any other feature or element in any other embodiment unless specifically restricted.

This disclosure includes and contemplates combinations with features and elements known to the average artisan in the art. The embodiments, features, and elements that have been disclosed may also be combined with any conventional features or elements to form a distinct invention as defined by the claims. Any feature or element of any embodiment may also be combined with features or elements from other inventions to form another distinct invention as defined by the claims. Therefore, it will be understood that any of the features shown and/or discussed in the present disclosure may be implemented singularly or in any suitable combination. Accordingly, the embodiments are not to be restricted except in light of the attached claims and their equivalents. Also, various modifications and changes may be made within the scope of the attached claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a schematic diagram of a system for refining a video language model, according to an embodiment.

FIG. 2 shows a text encoder, a text encoder and a video encoder with text and image embeddings projected into a shared video-text embedding space, according to an embodiment.

FIG. 3 discloses the difference between the output of a video language model before and after refining, according to an embodiment.

FIG. 4 shows a first iteration of training, according to an embodiment.

FIG. 5 shows generating synonym trees and generating new verb-object pairings

FIG. 6 shows a second iteration of training, according to an embodiment.

FIG. 7 shows a third iteration of training, according to an embodiment.

FIG. 8 shows a fourth iteration of training, according to an embodiment.

FIG. 9 shows leaf augmentation.

FIG. 10 shows a computer-implemented method of refining a video language model, according to an embodiment.

The figures depict various embodiments for purposes of illustration only. One skilled in the art will readily recognize from the following discussion that alternative embodiments of the structures and methods illustrated herein may be employed without departing from the principles of the embodiments described herein.

### DESCRIPTION OF EMBODIMENTS

Generally disclosed are embodiments of systems and methods of refining a video language model. The disclosed systems and methods can refine a video language model to identify unseen actions.

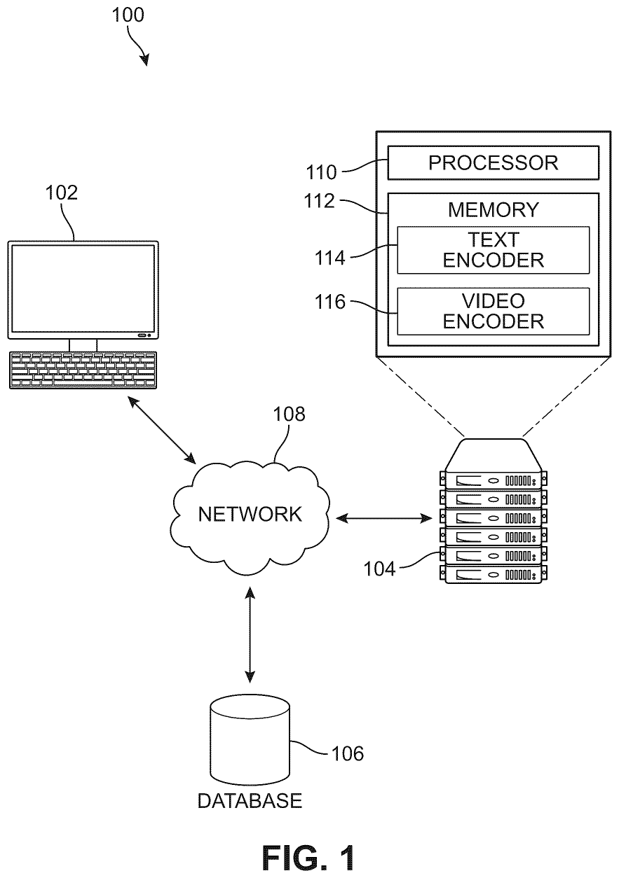

FIG. 1 is a schematic diagram of a system for refining a video language model 100 (or system 100), according to an embodiment. During use, a user may interact with the system to refine a video language model. The disclosed system may include a plurality of components capable of performing the disclosed computer implemented method. For example, system 100 includes a user device 102, a computing system 104, and a database 106. Database 106 may store information training data.

The components of system 100 can communicate with each other through a communication network 108. For example, user device 102 may retrieve training data from database 106 via communication network 108. In some embodiments, communication network 108 may be a wide area network (“WAN”), e.g., the Internet. In other embodiments, communication network 108 may be a local area network (“LAN”).

While FIG. 1 shows one user device, it is understood that one or more user devices may be used. For example, in some embodiments, the system may include two or three user devices. In some embodiments, the user devices may be computing devices used by a user. For example, user device 102 may include a smartphone or a tablet computer. In other examples, user device 102 may include a laptop computer, a desktop computer, and/or another type of computing device. The user devices may be used for inputting, processing, and displaying information. In some embodiments, a digital camera may be used to generate images used for analysis in the disclosed method. In some embodiments, the user device may include a digital camera that is separate from the computing device. In other embodiments, the user device may include a digital camera that is integral with the computing device, such as a camera on a smartphone or tablet.

As shown in FIG. 1, in some embodiments, a Video-Language Model (VLM) including a text encoder 114 (or pretrained text encoder G ( ) and video encoder 116 (or pretrained video encoder ε( ) or image encoder) can be hosted in a computing system 104. Generally, text encoder 114 can embed input data (e.g., text) and video encoder 116 can embed input data (e.g., video clips). Computing system 104 includes a processor 110 and a memory 112. Processor 110 may include a single device processor located on a single device, or it may include multiple device processors located on one or more physical devices. Memory 112 may include any type of storage, which may be physically located on one physical device, or on multiple physical devices. In some cases, computing system 104 may comprise one or more servers that are used to host the system.

While FIG. 1 shows a single user device, it is understood that more user devices may be used. For example, in some embodiments, the system may include two or three user devices. The user device may be a computing device used by a user for communicating with the system. In some embodiments, one or more of the user devices may include a smartphone or a tablet computer. In other embodiments, one or more of the user devices may include a laptop computer, a desktop computer, and/or another type of computing device. The user devices may be used for inputting, processing, and displaying information. The user device may include a display that provides an interface for the user to input and/or view information.

The disclosed embodiments enhance the ability of Video-Language Models to learn different embedding sub-spaces corresponding to procedural action concepts in the shared video-language embedding space. In the context of this specification, “concept sub-space” refers to the space that covers the text representations of all synonyms associated with an action.

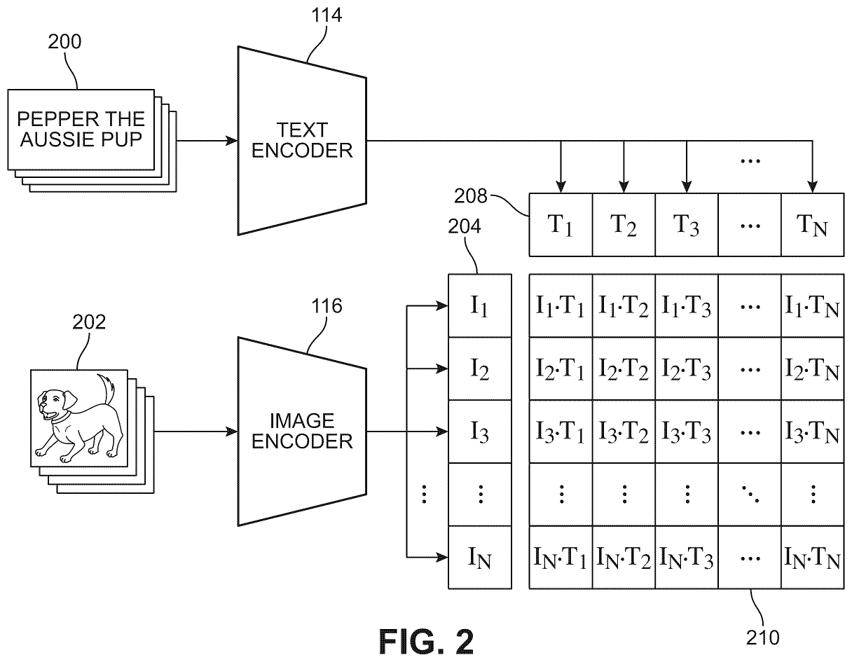

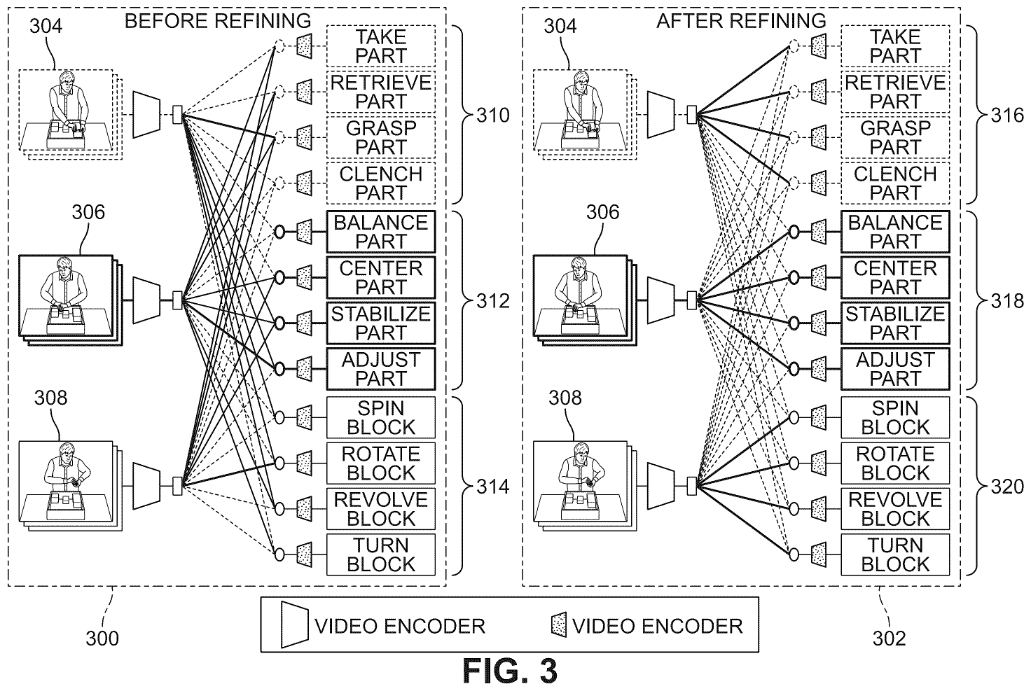

Video-Language Models (VLMs) can use zero-shot action recognition, where actions are identified even if not explicitly seen during training. For example, as shown in FIG. 2, text encoder 114 can process input text 200 to text embeddings 208 and video encoder 116 can separately process input video 202 to image embeddings 204. The VLM can project text embeddings 208 and image embeddings 204 into a shared video-text embedding space 210. A query video can be matched to the closest text representation from unseen action labels. Since the actions and labels are unseen during training, VLMs can encode the broader concept of an action rather than the exact label. This enables the model to match a query video to its action class, regardless of the synonym used. Essentially, text representations describing the same action class can be projected close to each other in the embedding space. For example, as shown in FIG. 3, a video of someone spinning a block 308 can be associated with the relevant action class including labels 314, which are shown as “spin block,” “rotate block,” “revolve block,” or “turn block.”

FIG. 3 discloses the difference between the output of a VLM before refining (first block 300) and after refining (second block 302). A first image 304, a second image 306, and a third image 308 can be frames from procedural videos. In first image 304, a person is grasping a part. In this example, a first set of verb-object pairings 310 are the closest pairings to the groundtruth corresponding to first image 304. In second image 306, a person is adjusting a part. In this example, a second set of verb-object pairings 312 are the closest pairings to the groundtruth corresponding to second image 306. In third image 308, a person is rotating a part. In this example, a third set of verb-object pairings 314 are the closest pairings to the groundtruth corresponding to third image 308. The lines connecting the images to the verb-object pairings indicate how strong the connection between the images and verb-object pairings, according to the VLM. For example, darkened lines indicate the strongest connections, regular continuous lines indicate medium connections, and dashed lines indicate the weakest connections. As shown “before refining” in block 300, the strength of connections are not very accurate in comparison to the strength of connections “after refining” in block 302.

Existing VLMs pretrained on large image-text datasets often exhibit bias towards objects, failing to capture temporal action elements like verbs. Other VLMs, pretrained on videos and internet transcripts, have text encodings that lack robustness, especially with fine-grained action synonyms in specialized and procedural domains. The disclosed embodiments overcome these shortcomings by improving VLM robustness and concept understanding.

Disclosed embodiments leverage the knowledge of a Large Language Model (LLM), such as GPT-4, to construct a synonym tree, where each node is an action label and its descendants are synonyms. During training, a classification loss function can be used where videos are classified into novel combinations of action synonyms and their negatives, randomly chosen from the tree. This method can generate numerous action label combinations, ensuring the model encounters new or rare action sets each iteration, simulating classification into unseen categories.

The augmented synonyms can introduce randomness and diversity, reducing overfitting to fixed verb representations, while negative labels can help reduce bias toward objects. The disclosed finetuning framework for VLMs can integrate in-domain contextualization with the pretrained knowledge, enhancing recognition of unseen actions and understanding corresponding concepts.

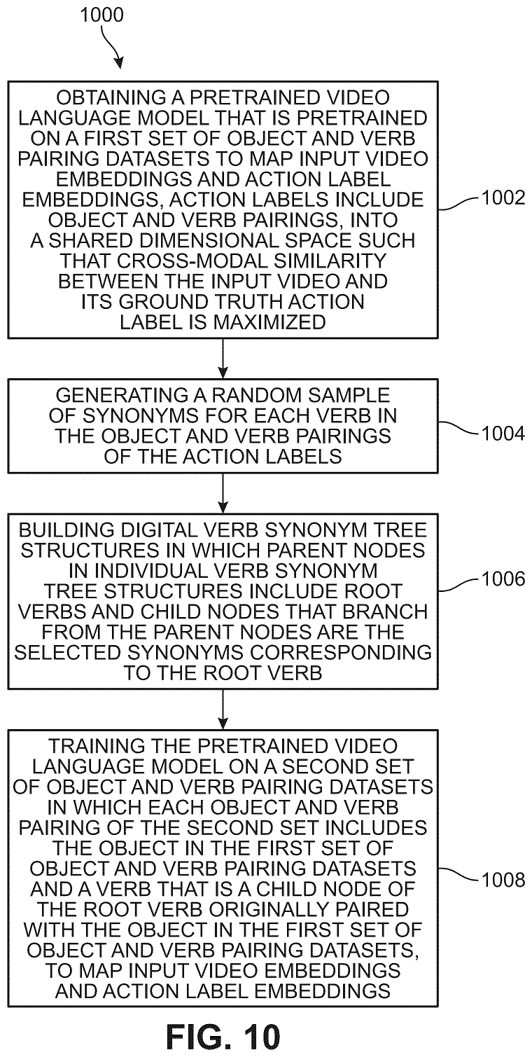

As discussed above, a video language model can include a video encoder processing video input to video embeddings and a text encoder processing text input to text embeddings. FIG. 10 shows a computer-implemented method of refining a video language model 1000 (or method 1000), according to an embodiment. The computer-implemented method of refining a video language model to identify unseen actions can include obtaining a pretrained video language model (operation 1002). In some embodiments, the pretrained video language model can be obtained from a third party. In other embodiments, the computer-implemented method can include pretraining the video language model. Pretraining of the video language model, in any embodiment, can include pretraining on a first set of object and verb pairing datasets to map input video embeddings and action label embeddings into a shared dimensional (or embedding) space such that cross-modal similarity between an input video and its ground truth action label is maximized. The action labels can include object and verb pairings.

During training, the input can be a batch of size B from trimmed procedural videos

$${\{ {I}_{n} \}}_{n = 1}^{B}$$

and corresponding ground-truth action indices

$${\{ {y}_{n} \}}_{n = 1}^{B} .$$

yₙ is the class index of the n^{th} video corresponding to one of the C seen action categories

$$a = {\{ a \}}_{n = 1}^{C} .$$

In this embodiment, the root or default labels of the seen action classes that are annotated in the dataset are a. The computer-implemented method can include training the pretrained video encoder ε( ) and text encoder [symbol] ( ) so that a trimmed test video can be correctly classified into one of the available action categories. Correct classification can be obtained by closely aligning the query video embedding with the text embedding of the corresponding groundtruth action in the shared embedding space. Two separate classification scenarios can be followed at test time: first, classifying a test video into one of the seen classes α; and second, classifying a test video into one of the previously unseen action labels

$${a}^{′} = {\{ {{a}^{′}}_{ι} \}}_{i = 1}^{{C}^{′}}$$

regardless or what action synonyms are used to describe these actions. This robustness especially impacts unseen actions as the model has not been optimized with, or expected, any of the unseen action labels.

The computer-implemented method of refining a video language model can include generating a random sample of synonyms for each verb in the object and verb pairings of the action labels (operation 1004). In some embodiments, generating a random sample of synonyms can include generating, by an LLM, the sample of synonyms.

As discussed below, the computer-implemented method of refining a video language model can include building digital verb synonym tree structures in which parent nodes in individual verb synonym tree structures include root verbs and child nodes that branch from the parent nodes are the selected synonyms corresponding to the root verb (operation 1006).

Any procedural action α can be decomposed into a verb ν and object ν pair, i.e., α=ν⊕∘. In this embodiment, functions that map action α to corresponding verb and object components, respectively, are defined as [symbol] ( ): α→ν. Let ν be the set of ┌ν┐ root/default verb labels corresponding to root actions α. Accordingly, for each νᵢ∈ν, a tree structure where νᵢ is the root can be established. More generally in a tree, each parent node represents a verb ν and its M children nodes ν+ are corresponding synonyms including verb ν itself. Every parent node can also replicated as a child to ensure previous information is preserved at each semantic level. Concretely, children of node ν are denoted as

$$𝓋 += {\{ {( 𝓋 + )}_{i} \}}_{i = 1}^{M} = Synonyms ( 𝓋 ) ⋃ \{ 𝓋 \}$$

where ∪ is the union operation and synonyms are generated by an LLM. Although the number of children remains consistent within each level in all trees, it can vary across different levels.

In some embodiments, each tree is as deep as only the second order synonyms, i.e., synonyms of synonyms. However, in other embodiments, such trees can extend to higher order synonyms. Semantically, each tree pertains to an action concept and as all trees grow deeper, action concepts start overlapping more with each other and become less discriminative. This is because the connection between some of the higher order synonyms and the root becomes looser which makes action concepts coarser as a result.

The proposed synonym trees can be integrated into the disclosed learning framework.

The computer-implemented method of refining a video language model can include training the pretrained video language model on a second set of object and verb pairing datasets, wherein each object and verb pairing of the second set includes the object in the first set of object and verb pairing datasets and a verb that is a child node of the root verb originally paired with the object in the first set of object and verb pairing datasets, to map input video embeddings and action label embeddings (operation 1008).

### Video-Label Alignment Loss

When training VLMs, video encoder ε( ) and text encoder [symbol] ( ) map the input video Iₙ and action labels α, respectively, into a shared D-dimensional space so that the cross-modal similarity S(Iₙ, α_{y}_{ₙ}) between video Iₙ and the corresponding groundtruth action label α_{y}_{ₙ} ∈α is maximized while the similarity of Iₙ with other actions is minimized. In other words, the goal is to align related representations and push apart unrelated ones in the shared embedding space. This alignment task is framed as a classification problem. Specifically, for a batch of input data, the cross-entropy loss function L_{fixed} is formulated below in order to maximize P(n, α), the probability of Iₙ belonging to class α_{y}_{ⁿ} given the pool of action labels:

$$a = {\{ {a}_{i} \}}_{i = 1}^{C} \qquad Equation 1$$

$$P ( n , a ) = \frac{{e}^{S ( {I}_{n} , {a}_{{y}_{n}} )}}{{\sum }_{i = 1}^{c} {e}^{S ( {I}_{n} , {a}_{i} )}} \qquad Equation 2$$

$${L}_{fixed} = - \frac{1}{B} {\sum }_{N = 1}^{B} log ( P ( n , a ) ) . \qquad Equation 3$$

Here, the cross-modal similarity measure S(I, α) is defined as the average of cosine similarities between the video embedding and the text embeddings of M children of action a:

$$S ( I , a ) = \frac{1}{τ M} {\sum }_{i = 1}^{M} < ε ( I ) , 𝒢 ( {( {a}^{+} )}_{i} ) > \qquad Equation 4$$

where τ is the pre-defined temperature, <·,·> indicates cosine similarity between two normalized embeddings, and (α⁺)ᵢ=( [symbol] (α)⁺)ᵢ⊕◯(α). There are three main advantages in augmenting an action by the average of its synonyms: first, using the average of synonyms alone brings related labels closer together through shared synonyms. Second, it helps to describe actions that the text encoder is less familiar with by leveraging more recognizable synonyms. Third, it simply adds more in-domain textual data for the model to learn from.

### Randomized Action Synonyms

The action concept enhancement can be further modeled as an auxiliary classification task where the pool of available action labels is randomly augmented from the set of known root actions α. Firstly, \tilde{x} can be defined as a sample randomly selected from the set x. Accordingly, [symbol] refers to a verb randomly sampled from the synonyms of verb [symbol] (αᵢ) associated with action αᵢ. Then, the verb synonym trees and Equation 2 can be leveraged to extend L_{fixed} (Equation 3) by adding the auxiliary classification loss L_{rand} (Equation 7) to yield Equation 6. Essentially, through L_{rand}, each video can be categorized into one of the C action classes labeled by a new set of randomized action synonyms [symbol] at each training iteration. In detail, as specified below, [symbol] is a random augmentation of seen action classes, where each action class is represented by a corresponding randomly chosen verb synonym:

$$= {\{ ⊕ ( {a}_{i} ) \}}_{i = 1}^{C} = {\{ \}}_{i = 1}^{C} , \qquad Equation 5$$

$$L = - \frac{1}{B} {\sum }_{n = 1}^{B} log ( P ( n , a ) ) - \frac{1}{B} {\sum }_{n = 1}^{B} log ( P ( n , ) ) \qquad Equation 6$$

$${L}_{rand} = - \frac{1}{B} {\sum }_{n = 1}^{B} log ( P ( n , ) ) \qquad Equation 7$$

While for L_{rand} a new set of randomized action synonyms [symbol] is constructed per training iteration, L_{fixed} uses the fixed root action labels throughout the entire training.

Consequently, in each training iteration, each batch of videos can be classified twice: once using the root labels and once using their randomized synonyms.

In embodiments where root action labels are manually annotated in each dataset, the descriptions of action concepts tend to be more precise when compared to artificial intelligence generated synonyms. Hence, the set of root labels in L_{fixed} is fixed and serves as a reference point, which makes the video-language encoders learn the connection between synonyms and root action labels within an action concept sub-space.

Meanwhile, variable action labels in L_{rand} prevent video-language encoders from overfitting to a single label, and instead learn the concept of an action and different representations within that concept sub-space. This enhances robustness to unseen action synonyms, and is beneficial in zero-shot recognition where actions and corresponding labels are unknown.

Our randomized augmentation technique can create up to M^{C} different action label combinations which are rarely repeated during training. Effectively, this simulates test time classification where videos are categorized into unseen action labels.

Applying the similarity measure S to first order synonyms in Equation 6 allows VLMs to learn action concepts based on second order synonyms of the tree.

### Shadow Negatives

Varying action synonyms through replacement of their verb components can bias the encoders to only objects. In other words, encoders learn to align videos to their correct action labels by only focusing on the object component which defeats the purpose of concept learning. In order to alleviate this limitation, shadow negatives are introduced as a (C=1)^{th} category during classification. The shadow negative action shares the same object as the true action label, however, it pairs with a wrong verb. This approach compels the model to learn the verbs as well to accurately distinguish between the true label and a corresponding shadow negative. Specifically, the verb synonym trees can define the pool of shadow negative verbs [symbol] (αᵢ)—associated with the root action αᵢ∈α as:

$$𝒱 ( {a}_{i} ) -= {U}_{j = 1}^{C} ( 𝒱 ( {a}_{j} ) + ∖ {𝒱 ( {a}_{i} )}^{+} ) \qquad Equation 8$$

where “\” refers to the set difference, i.e., children of [symbol] (αⱼ) that are not among the children of [symbol] (αᵢ). At the beginning of each training iteration, for every class i, a shadow negative action [symbol] can be constructed via randomly sampling from the pool of negative verbs [symbol] (αᵢ)—of that action:

$$= 𝒱 ⊕ ( {a}_{i} ) \qquad Equation 9$$

Then, P(n, α, [symbol] ) can be updated as the probability of video Iₙ belonging to class α_{y}_{ₙ}∈α given the pool of positive action labels α and shadow negative α_{y}_{ₙ}⁻. Adding the shadow negative associated with the true action label of each video, extends the classification to C+1 classes:

$$P ( n , a , ) = \frac{{e}^{S ( {I}_{n} , {a}_{{y}_{n}} )}}{{\sum }_{i = 1}^{c} {e}^{S ( {I}_{n} , {a}_{i} )} + {e}^{S ( {I}_{n} , )}} \qquad Equation 10$$

As a result, the final loss can be modified as follows:

$${L}_{f} = - \frac{1}{B} {\sum }_{n = 1}^{B} log ( P ( n , a , ) ) + log ( P ( n , ) ) \qquad Equation 11$$

$${L}_{fixed} = log ( P ( n , a , ) ) \qquad Equation 12$$

$${L}_{rand} = log ( P ( n , ) ) \qquad Equation 13$$

In some embodiments, an algorithm can begin by building the verb synonym trees with the following equation:

$${\{ T ( 𝒱 ( {a}_{i} ) ) \}}_{i = 1}^{C} \qquad Equation 14$$

Next, at the beginning of each training iteration, as a batch is processed, new randomized sets of action synonyms [symbol] and shadow negatives [symbol] can be generated. These along with root labels α and their respective children can be encoded by the text encoder. Through Equation 11, the algorithm then engages each encoded video into two classification tasks involving C+1 categories. Consequently, this process encourages video encoder ε( ) and text encoder g( ) to explore each action concept by stochastically aligning videos and synonyms within their corresponding concept sub-space.

During inference, classify query video Iₙ can be classified into the action class that has the highest similarity measure S with the query video, i.e., argmax [symbol] S(Iₙ, α). Inference can be done in two separate modes of base and novel, where [symbol] is the set of known classes α in the base mode and the set of unseen classes \acute{α} in the refining mode. In addition, in both base and refining modes, synonym trees can be constructed, so [symbol] can be represented by the root action labels or the synonyms of the root labels. In some embodiments, shadow negatives are not used during inference.

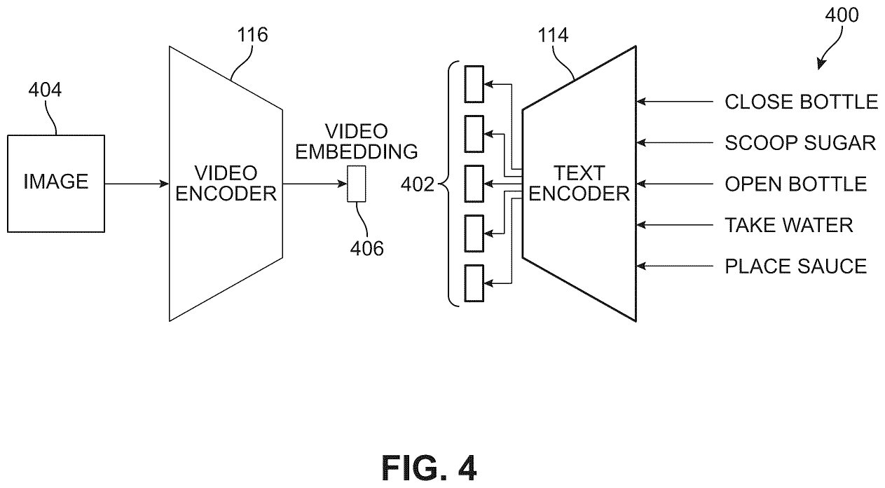

FIGS. 4-9 show various training iterations, according to an embodiment. FIG. 4 shows a first iteration of training. FIG. 4 shows first verb-object pairings 400 corresponding to an image (e.g., frame from a video) 404. First verb-object pairings 400 can be groundtruth labels. In FIG. 4, first verb-object pairings 400 can be input into text encoder 114 to generate first text embeddings 402 and image 404 can be input into video encoder 116 to generate a first video embedding 406. The VLM can project first text embeddings 402 and first video embedding 406 into a shared video-text embedding space.

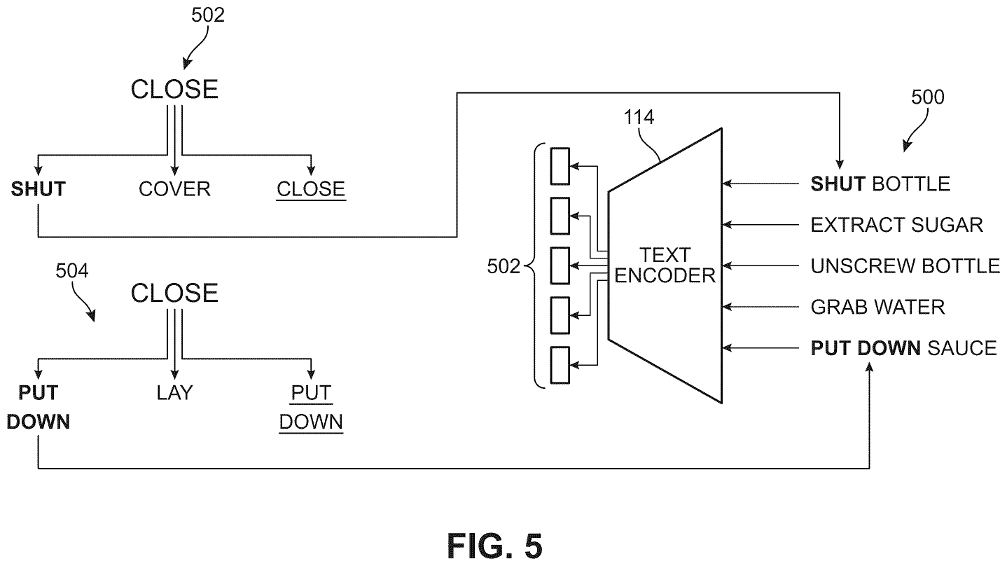

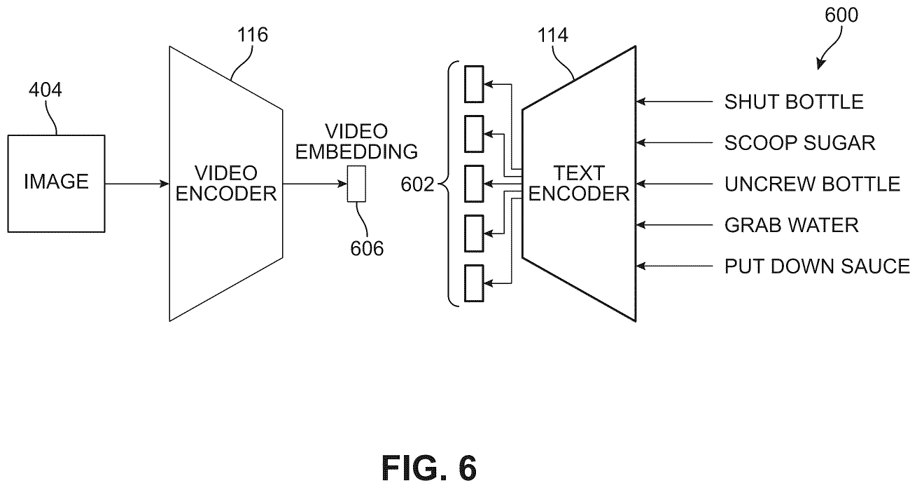

FIG. 5 shows generating synonym trees and generating new verb-object pairings. A first synonym tree 502 and a second synonym tree 504 can be generated. Synonyms for verbs from verb-object groundtruth pairings can be the root node and the synonyms can be randomly selected (e.g., by an LLM). Both synonym trees are based on the verb “close” which is a verb used in a groundtruth verb-object pairing from FIG. 4. The underlining in FIG. 5 indicates duplicates appearing in the synonym trees. FIG. 6 shows a second iteration of training. As shown in this example, this iteration of training includes generating second verb-object pairings 600 in which terms from the generated synonym trees are paired with objects from verb-object pairings 400. In FIG. 6, second verb-object pairings 600 can be input into text encoder 114 to generate second text embeddings 602 and image 404 can be input into video encoder 116 to generate a second video embedding 606. The VLM can project second text embeddings 602 and a second video embedding 606 into a shared video-text embedding space.

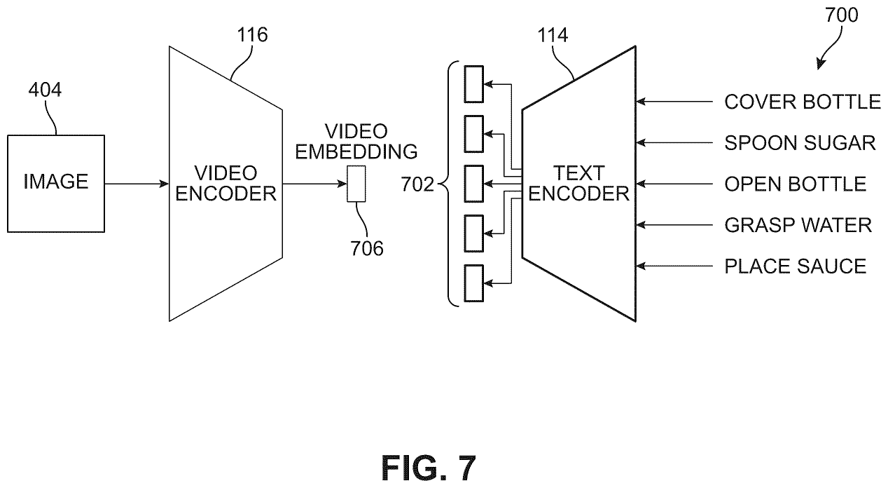

FIG. 7 shows a third iteration of training. In this example, synonym trees (not shown) can be generated. Similar to FIG. 6, synonyms for verbs from verb-object groundtruth pairings can be the root node and the synonyms can be randomly selected and included as child nodes. As shown in this example, this iteration of training includes generating third verb-object pairings 700 in which terms from the generated synonym trees are paired with objects from verb-object pairings 400. In FIG. 7, third verb-object pairings 700 can be input into text encoder 114 to generate third text embeddings 702 and image 404 can be input into video encoder 116 to generate third video embedding 706. The VLM can project third text embeddings 702 and third image embedding 706 into a shared video-text embedding space.

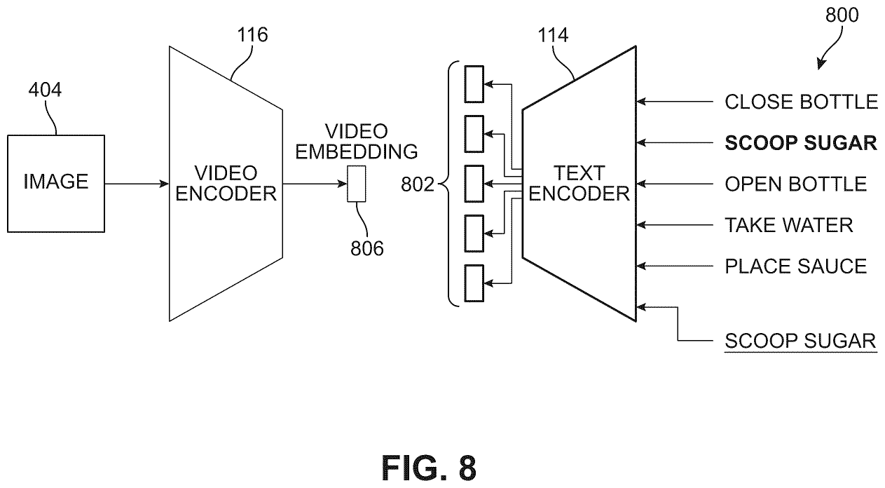

FIG. 8 shows a fourth iteration of training. In this example, synonym trees (not shown) can be generated. Similar to FIGS. 6-7, synonyms for verbs from verb-object groundtruth pairings can be the root node and the synonyms can be randomly selected and included as child nodes. As shown in this example, this iteration of training includes generating third verb-object pairings 800 in which terms from the generated synonym trees are paired with objects from verb-object pairings 400. In addition to including verb-object pairings with synonyms, this iteration can include generating a verb-object pairing in which a negative verb (i.e., a verb that is not descriptive of the action in the video) can be paired with an object from verb-object pairings 400. In this case, “scoop” is the negative verb and “scoop sugar” is the shadow negative pairing (label) included in third verb-object pairings 800. In FIG. 8, fourth verb-object pairings 800 can be input into text encoder 114 to generate fourth text embeddings 802 and image 404 can be input into video encoder 116 to generate fourth video embedding 806. The VLM can project fourth text embeddings 802 and fourth image embedding 806 into a shared video-text embedding space. The use of a shadow negative in the fourth iteration of training can prevent overfitting to the objects in verb-object pairings 400.

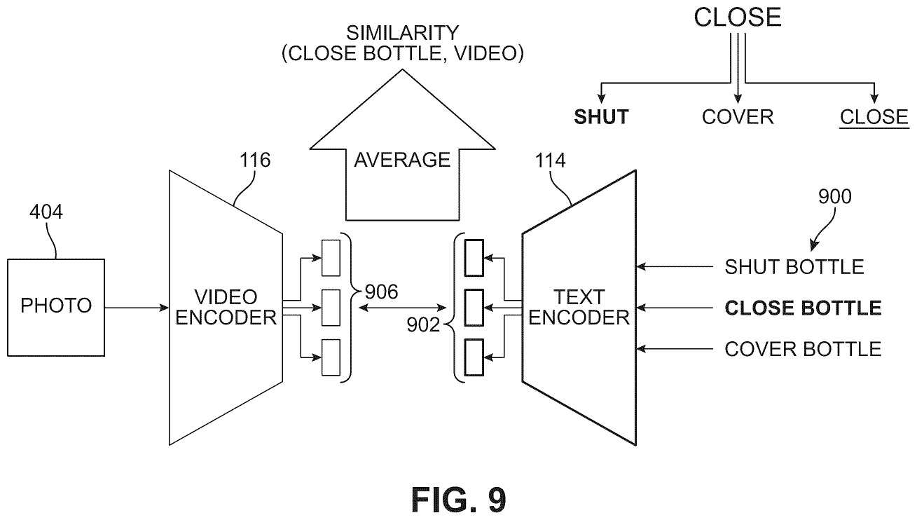

FIG. 9 shows leaf augmentation. Leaf augmentation is a representation of an action by the average of corresponding synonyms in the similarity measure calculated by Equation 4. In FIG. 9, fourth verb-object pairings 900 can be input into text encoder 114 to generate fourth text embeddings 902 and image 404 can be input into video encoder 116 to generate fifth video embedding 906. The similarity of a label with a query video can be calculated as the average similarity between synonyms corresponding to a label and a query video. Leaf augmentation can connect videos to synonyms of synonyms, which can provide more text data.

Embodiments may include a non-transitory computer-readable medium (CRM) storing software comprising instructions executable by one or more computers which, upon such execution, cause the one or more computers to perform the disclosed methods. Non-transitory CRM may refer to a CRM that stores data for short periods or in the presence of power such as a memory device or Random Access Memory (RAM). For example, a non-transitory computer-readable medium may include storage components, such as, a hard disk (e.g., a magnetic disk, an optical disk, a magneto-optic disk, and/or a solid-state disk), a compact disc (CD), a digital versatile disc (DVD), a floppy disk, a cartridge, and/or a magnetic tape.

Embodiments may also include one or more computers and one or more storage devices storing instructions that are operable, when executed by the one or more computers, to cause the one or more computers to perform the disclosed methods.

Certain embodiments may use cloud computing environments. Cloud computing environments can include, for example, an environment that hosts the services for impact analysis and detection described herein. The cloud computing environment may provide computation, software, data access, storage, etc. services that do not require end-user knowledge of a physical location and configuration of system(s) and/or device(s) that hosts the impact analysis and detection services. For example, a cloud computing environment may include a group of computing resources (referred to collectively as “computing resources” and individually as “computing resource”).

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

While various embodiments of the disclosure have been described, the description is intended to be exemplary, rather than limiting and it will be apparent to those of ordinary skill in the art that many more embodiments and implementations are possible that are within the scope of the disclosure. Various modifications and changes may be made within the scope of this disclosure.

We claim:

1. A computer-implemented method of refining a video language model to identify unseen actions, comprising:
obtaining a pretrained video language model that is pretrained on a first set of object and verb pairing datasets to map input video embeddings and action label embeddings, wherein action labels include object and verb pairings, into a shared dimensional space such that cross-modal similarity between an input video and its ground truth action label is maximized;
generating a random sample of synonyms for each verb in the object and verb pairings of the action labels;
building digital verb synonym tree structures in which parent nodes in individual verb synonym tree structures include root verbs and child nodes that branch from the parent nodes are the selected synonyms corresponding to the root verb;
training the pretrained video language model on a second set of object and verb pairing datasets, wherein each object and verb pairing of the second set includes the object in the first set of object and verb pairing datasets and a verb that is a child node of the root verb originally paired with the object in the first set of object and verb pairing datasets, to map input video embeddings and action label embeddings.

2. The computer-implemented method of claim 1, wherein generating a random sample of synonyms includes generating, by a large language model, the sample of synonyms.

3. The computer-implemented method of claim 1, wherein obtaining the pretrained video language model includes pretraining a pretrained video language model on a first set of object and verb pairing datasets to map input video embeddings and action label embeddings, wherein action labels include object and verb pairings, into a shared dimensional space such that cross-modal similarity between the input video and its ground truth action label is maximized.

4. The computer-implemented method of claim 1, further comprising:
generating a random sample of negative verbs for each verb in the object and verb pairings of the action labels;
training the pretrained video language model on a third set of object and verb pairing datasets, wherein each object and verb pairing of the third set includes the object in the second set of object and verb pairing datasets and a negative verb of the generated random sample of negative verbs, to map input video embeddings and action label embeddings.

5. The computer-implemented method of claim 1, wherein the pretrained video language model includes a pretrained video encoder and a pretrained text encoder.

6. The computer-implemented method of claim 1, further comprising:
generating a video embedding by the pretrained video encoder; and
generating a text embedding by the pretrained text encoder.

7. The computer-implemented method of claim 1, wherein the input video is a procedural video.

8. A system for refining a video language model to identify unseen actions, comprising:
one or more computers and one or more storage devices storing instructions that are executable by the one or more computers to:
obtain a pretrained video language model that is pretrained on a first set of object and verb pairing datasets to map input video embeddings and action label embeddings, wherein action labels include object and verb pairings, into a shared dimensional space such that cross-modal similarity between an input video and its ground truth action label is maximized;
generate a random sample of synonyms for each verb in the object and verb pairings of the action labels;
build digital verb synonym tree structures in which parent nodes in individual verb synonym tree structures include root verbs and child nodes that branch from the parent nodes are the selected synonyms corresponding to the root verb;
train the pretrained video language model on a second set of object and verb pairing datasets, wherein each object and verb pairing of the second set includes the object in the first set of object and verb pairing datasets and a verb that is a child node of the root verb originally paired with the object in the first set of object and verb pairing datasets, to map input video embeddings and action label embeddings.

9. The system of claim 8, wherein generating a random sample of synonyms includes generating, by a large language model, the sample of synonyms.

10. The system of claim 8, wherein obtaining the pretrained video language model includes pretraining a pretrained video language model on a first set of object and verb pairing datasets to map input video embeddings and action label embeddings, wherein action labels include object and verb pairings, into a shared dimensional space such that cross-modal similarity between the input video and its ground truth action label is maximized.

11. The system of claim 8, wherein the instructions are further executable by the one or more computers to:
generate a random sample of negative verbs for each verb in the object and verb pairings of the action labels;
train the pretrained video language model on a third set of object and verb pairing datasets, wherein each object and verb pairing of the third set includes the object in the second set of object and verb pairing datasets and a negative verb of the generated random sample of negative verbs, to map input video embeddings and action label embeddings.

12. The system of claim 8, wherein the pretrained video language model includes a pretrained video encoder and a pretrained text encoder.

13. The system of claim 8, wherein the instructions are further executable by the one or more computers to:
generate a video embedding by the pretrained video encoder; and
generate a text embedding by the pretrained text encoder.

14. The system of claim 8, wherein the input video is a procedural video.

15. A non-transitory computer-readable medium storing software comprising instructions that are executable by one or more computers to refine a video language model to identify unseen actions by:
obtaining a pretrained video language model that is pretrained on a first set of object and verb pairing datasets to map input video embeddings and action label embeddings, wherein action labels include object and verb pairings, into a shared dimensional space such that cross-modal similarity between an input video and its ground truth action label is maximized;
generating a random sample of synonyms for each verb in the object and verb pairings of the action labels;
building digital verb synonym tree structures in which parent nodes in individual verb synonym tree structures include root verbs and child nodes that branch from the parent nodes are the selected synonyms corresponding to the root verb;
training the pretrained video language model on a second set of object and verb pairing datasets, wherein each object and verb pairing of the second set includes the object in the first set of object and verb pairing datasets and a verb that is a child node of the root verb originally paired with the object in the first set of object and verb pairing datasets, to map input video embeddings and action label embeddings.

16. The non-transitory computer-readable medium of claim 15, wherein generating a random sample of synonyms includes generating, by a large language model, the sample of synonyms.

17. The non-transitory computer-readable medium of claim 15, wherein obtaining the pretrained video language model includes pretraining a pretrained video language model on a first set of object and verb pairing datasets to map input video embeddings and action label embeddings, wherein action labels include object and verb pairings, into a shared dimensional space such that cross-modal similarity between the input video and its ground truth action label is maximized.

18. The computer-implemented method of claim 15, wherein the instructions are further executable by the one or more computers to:
generate a random sample of negative verbs for each verb in the object and verb pairings of the action labels;
train the pretrained video language model on a third set of object and verb pairing datasets, wherein each object and verb pairing of the third set includes the object in the second set of object and verb pairing datasets and a negative verb of the generated random sample of negative verbs, to map input video embeddings and action label embeddings.

19. The computer-implemented method of claim 15, wherein the pretrained video language model includes a pretrained video encoder and a pretrained text encoder.

20. The computer-implemented method of claim 15, wherein the instructions are further executable by the one or more computers to:
generate a video embedding by the pretrained video encoder; and
generate a text embedding by the pretrained text encoder.
